(19) United States
(12) Patent Application Publication
(10) Pub. No.: US 2006/0033739 A1
(43) Pub. Date: Feb. 16, 2006

(54) Apparatus and method of defining a sequence of views prior to production

(76) Inventor: Wilson John Tang, Fairfax, CA (US)

Correspondence Address: LAW OFFICES OF MARK C. PICKERING, P.O. BOX 300, PETALUMA, CA, 94953, US

(21) Appl. No.: 10/261,813

(22) Filed: Sep. 30, 2002

(51) Int. Cl. G06T 15/70

(52) U.S. Cl. 345/473

(57) ABSTRACT

The accuracy of the cost estimates to produce a sequence of views that include computer animation is increased by recording different views of a computer-generated object that follows an action sequence in a computer-generated world. The different views can then be edited to produce a sequence of views that is similar to the final sequence of views that are shown on screen to the public.

### BACKGROUND OF THE INVENTION

1. Field of the Invention

The present invention relates to the sequence of views in a motion picture and, more particularly, to an apparatus and method of defining the sequence of views prior to production.

2. Description of the Related Art

Current-generation motion pictures commonly utilize special effects to produce realistic representations of creatures and worlds that do not exist. Star Wars™ and similar movies are examples of motion pictures that bring to life alien creatures and worlds in a truly believable fashion.

The range of special effects runs from the simplistic to the highly complex. For example, in shots where the background is an alien planet that is only vaguely identifiable, a relatively simple matte painting is sufficient to provide the desired effect. On the other hand, state-of-the-art computer animation is required to produce realistic alien creatures that interact with human or other alien creatures in an alien world.

One of the problems in computer animation is that it is difficult to estimate the cost of production. One of the reasons is that the production cost is largely based on the level of detail that is required by each frame, and the number of frames that need to be animated. To determine these values, a cost estimator must have a rough idea of the objects to be animated, and the sequence of views that will be seen by the public. The sequence of views, however, is difficult to define prior to production.

In addition, one frame of computer animation can take many hours of computer time to produce. As a result, a frame of computer animation is relatively expensive. Thus, not only is it difficult to define the sequence of views, and thereby the level of detail and the number of required frames, but a project that requires significantly more detail or frames than expected can result in the project losing money due to the high cost of producing a single frame.

Although a script or a near-final version of a script is available prior to production, the script, which recites dialog in great detail, typically only defines the sequence of action in a scene in broad strokes. For example, a script may describe a scene where a horseman rides down a lane to a small village past attacking creatures at the entrance to the village. The horseman continues into the center of the village where the horseman is again attacked by the village creatures. The horseman slays several creatures and escapes into a building in the village.

The script, however, does not define the sequence of views that will be seen on the screen by the public. For example, the script does not state, begin with a side view and follow the horseman riding down the lane, cut to a close up view of the horse's face, and then cut to a close up view of the attacking creatures at the entrance to the village. Rather, the director determines the objects that are to be animated in a scene, such as the attacking creatures, and the sequence of views that will be seen by the public.

One technique that is used to help estimate the cost of production is to generate a rough approximation of the sequence of views. To generate a rough approximation, a sequence of views is defined, ideally at the guidance of the director. The sequence of views can be, for example, begin with a side view of the horseman riding down the lane, cut to a close up view of the horse's face, and then cut to a close up view of the attacking creatures at the entrance to the village.

Next, in a process known as key framing, key frames of each segment of the sequence, such as the horseman riding down the lane, are roughly generated. A computer is then used to generate the in between frames showing the horseman riding down the lane. The segments are then put together to form a rough version of the sequence of views that the public will see. The rough version is presented to the director. If approved by the director, cost estimates are made based on the rough version.

Often, however, what the director initially thought would be a good sequence of views is not acceptable after a visual review. Sometimes this requires only a minor modification to a number of frames, but other times this requires a large number of frames be significantly re-animated at a significant cost.

Thus, although the rough version of the sequence of views allows the task to be somewhat bounded, there is a need for a method of estimating the costs of providing animation that more closely matches the actual costs incurred.

### SUMMARY OF THE INVENTION

The present invention provides a method of defining a sequence of views. The method includes the steps of generating a computer-generated object that follows an action sequence in a computer-generated world, and recording a first view of the computer-generated world to form a first recorded view. The first recorded view has a time duration from a first record time to a first stop time.

In addition, the method includes the step of recording a second view of the computer-generated world to form a second recorded view. The second recorded view has a time duration from a second record time to a second stop time. The first view and the second view are different.

The present invention also includes an apparatus that defines a sequence of views. The apparatus includes means for generating a computer-generated object that follows an action sequence in a computer-generated world, and means for recording a first view of the computer-generated world to form a first recorded view. The first recorded view has a time duration from a first record time to a first stop time.

Further, the apparatus additionally includes means for recording a second view of the computer-generated world to form a second recorded view. The second recorded view has a time duration from a second record time to a second stop time. The first view and the second view are different.

A better understanding of the features and advantages of the present invention will be obtained by reference to the following detailed description and accompanying drawings that set forth an illustrative embodiment in which the principles of the invention are utilized.

### BRIEF DESCRIPTION OF THE DRAWINGS

FIG. 1 is a block diagram illustrating an example of a computer 100 in accordance with the present invention.

FIG. 2 is a flow chart illustrating an example of a method 200 of defining a sequence of views in a motion picture prior to production in accordance with the present invention.

FIG. 3 is a flow chart illustrating an example of a method 300 of recording a view during an action sequence in accordance with the present invention.

FIG. 4 is a view illustrating an example of an image 400 that is output by display system 114 after a view has been recorded in accordance with the present invention.

FIG. 5 is a view illustrating an example of an image 500 that is output by display system 114 after a number of views have been recorded in accordance with the present invention.

FIG. 6 is a flow chart illustrating an example of a method 600 of editing the recorded views in accordance with the present invention.

FIG. 7 is a view illustrating an example of an image 700 that is output by display system 114 after a number of views have been edited to form an edited sequence of action in accordance with the present invention.

### DETAILED DESCRIPTION OF THE INVENTION

The present invention is an apparatus and method of defining a sequence of views in a motion picture prior to production. As described in greater detail below, the present invention provides a director with the flexibility to produce a sequence of views prior to production that is very close to the final sequence of views that will be seen on screen by the public. Thus, by giving the director the tools to accurately visualize the sequence of views prior to production, the level of detail and the number of required frames can be more accurately estimated.

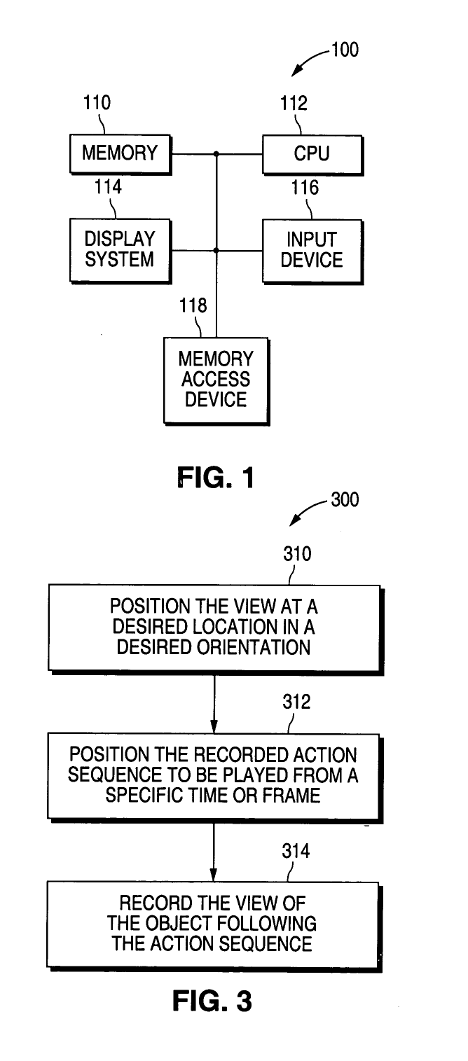

The apparatus of the present invention includes a computer and software that is executed by the computer. FIG. 1 shows a block diagram that illustrates an example of a computer 100 in accordance with the present invention. As shown in FIG. 1, computer 100 includes a memory 110 that stores software and data. The software includes an operating system and a set of program instructions.

As further shown in FIG. 1, computer 100 also includes a central processing unit (CPU) 112 that is connected to memory 110. CPU 112, which can be implemented as, for example, a 32-bit processor, operates on the data in response to the program instructions. Although only one processor is described, the present invention can be implemented with multiple processors in parallel to increase the capacity to process large amounts of data.

In addition, computer 100 includes a display system 114 that is connected to CPU 112. Display system 114 displays images to the user which are necessary for the user to interact with the program. Computer 100 also includes a user-input device 116, such as a keyboard and a pointing device, e.g., a mouse, which is connected to CPU 112. The user operates input device 116 to interact with the program.

Further, computer 100 includes a memory access device 118, such as a disk drive or a networking card, which is connected to memory 110 and CPU 112. Memory access device 118 allows the processed data from memory 110 or CPU 112 to be transferred to an external medium, such as a disk or a networked computer. In addition, device 118 allows the program instructions to be transferred to memory 110 from the external medium.

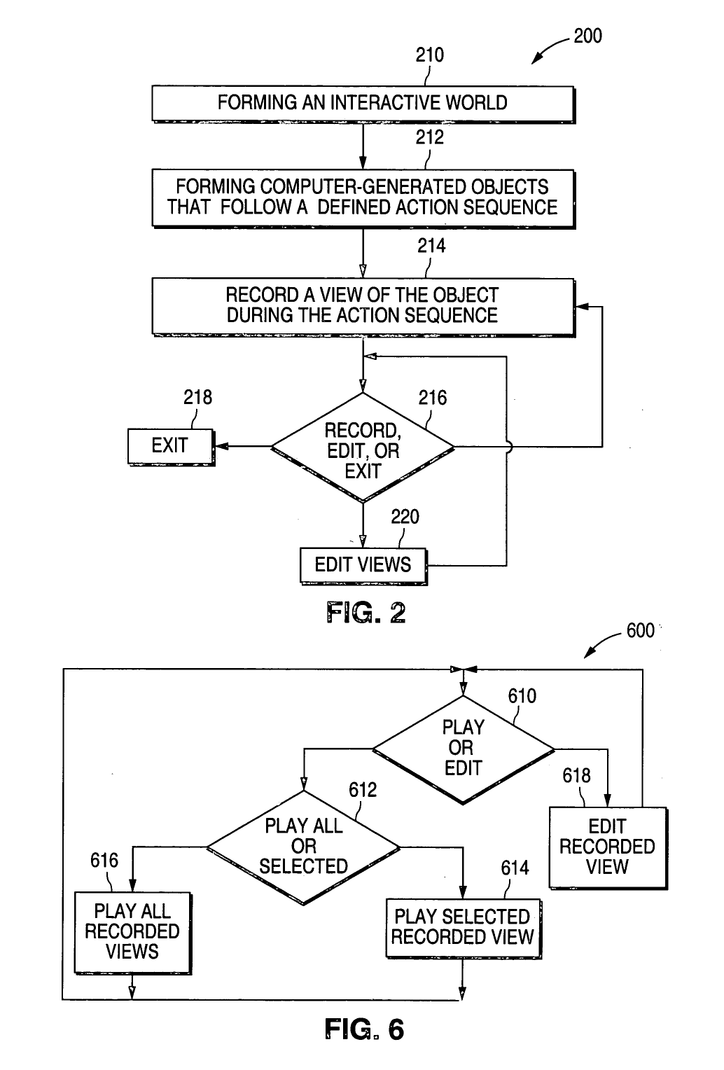

FIG. 2 shows a flow chart that illustrates an example of a method 200 of defining a sequence of views in a motion picture prior to production in accordance with the present invention. Steps within method 200 are implemented in software which is executed by computer 100.

As shown in FIG. 2, method 200 begins at step 210 with the formation of a computer-generated world. The computer-generated world includes the instructions and data that are required to generate a view data set. Display system 114, in turn, utilizes the view data set to display an image that represents a view of the world.

The computer-generated world also includes the instructions and data that are required to modify the view data set, and therefore the view, in response to a number of movement commands input by a user. The movement commands include, for example, forward, backward, left, right, and stop.

In addition, up and down commands are also available. When movement commands are detected, computer 100 modifies the view data set at a rate that causes display system 114 to display a sequence of images that provide the appearance that the view is moving through the world.

In combination, the movement commands allow the view to have any orientation, and move through the world in any direction. The ability to provide a view of a computer-generated world, and the appearance of the view moving through the world, are common features in computer games, such as Everquest™ and Doom™.

The steps required to generate the computer-generated world are well known, and are based on an existing instruction and data set such as, for example, a game engine. To generate a computer-generated world, a user need only modify the game engine to input data that describes the surfaces and the objects that lie within the world. Commercial software applications, such as SoftImage™ manufactured by SoftImage, Inc., provide a game engine and software that allow a computer-generated world to be created.

For example, the data input to generate a computer-generated world can include the information necessary to describe a tree-lined lane that leads to a small village that has a village center, and a number of buildings that surround the village center. Once the computer-generated world has been formed, the user is able to move the view through the world as desired, such as by moving down the lane and into the village center.

Once the computer-generated world has been formed, method 200 moves to step 212 to form computer-generated objects that follow a defined action sequence through the world that is independent of the view. The action sequence is defined to start at a beginning location at a beginning time or frame, run for a movement period of time or frames, and finish at an ending location at an ending time or frame.

For example, a computer-generated horse and horseman can be utilized as objects. In this example, the action sequence can begin with the horse and horseman at the far end of the lane away from the village, continue along the lane to the village, and into the village center. The action sequence can continue with the horse rearing up, the horseman dismounting, and slaying two creatures. In addition, the action sequence can end with the horseman running towards and entering a nearby building.

The action sequence is recorded and can be played in full, or any part of the action sequence can be played. For example, if the full action sequence is played, the action sequence begins with the horse and horseman at the far end of the lane, and ends with the horseman entering the nearly building. On the other hand, if the only portion of the action sequence that is of interest is the horseman dismounting and slaying two creatures, then only this section of the action sequence can be played.

The steps required to form an object that follows a defined action sequence through the world, and moves independently of the view are conventional and known in the art. For example, in the game Everquest™, a player is presented with a view of an alien world. At frequent intervals, a creature following a defined path enters the player's view. The player can move the view through the world independently of the movement of the creature, approach and circle the creature, and view the creature from all sides as the creature follows the defined path.

Once the objects and the defined action sequence have been formed, method 200 moves to step 214 to record a view of the object during the action sequence. FIG. 3 shows a flow chart that illustrates a method 300 of recording a view during an action sequence in accordance with the present invention.

As shown in FIG. 3, method 300 begins at step 310 with the user entering movement commands that position the view at a desired location in a desired orientation in the computer-generated world. The user can input movement commands that position the view at any location with respect to the movement of the objects within the action sequence.

For example, assume the view is positioned at a point mid on the lane looking away from the village. If the action sequence is played from the beginning, the image of an approaching horseman appears in the view. On the other hand, if the action sequence is played from when the horseman first dismounts, then the action of the horseman dismounting from the horse would not appear in the view as the view is looking away from the village.

The view can be placed at a fixed location with a fixed orientation, or can move from a first location to a second location during the sequence of action. To move the view during the action sequence, the user inputs movement commands at the same time that the object is following the action sequence.

For example, the view can remain fixed until the object following the action sequence reaches a predetermined point, and then moves with the object at the same direction and speed for a period of time or a number of frames. Thus, the location and movement of the view is independent of the recorded action sequence.

In addition, the view can, while at a fixed location or moving between locations, rotate about an axis during the sequence of action. For example, when the horseman passes, the user can rotate the view 180° so that the image displayed by display system 114 follows the approaching and passing horseman, with the image of the horseman then getting smaller and smaller as the horseman appears to get farther and farther away.

Following this, method 300 moves to step 312 where the user positions the recorded action sequence to be played from a specific time or frame. Since the action sequence is recorded, the sequence can be positioned to begin at any time or frame. (Steps 310 and 312 can alternately be interchanged.)

Next, method 300 moves to step 314 to record the view of the object following the action sequence. For example, assume that at step 310 the user positions the view to be part way down the lane looking away from the horseman towards the village. Further, assume that the horseman first enters the view at time six seconds or frame 180, and that the user positions the action sequence to begin at five seconds or frame 150.

The user then issues the play and record commands. In response to the play command, the object follows the action sequence beginning from time five seconds or frame 150. In response to the record command, the view is recorded. As a result, the action recorded by the view is a one second or 30 frame view of an empty lane, followed by an image of a horseman entering the view and galloping away towards the village. A stop command can then be issued at any time, such as at frame 250, to stop recording.

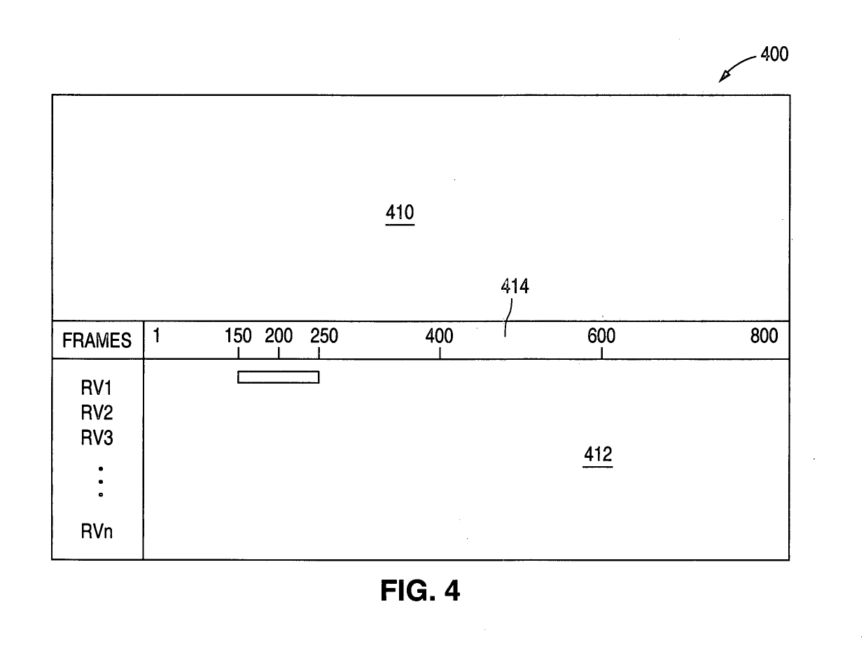

FIG. 4 shows a view that illustrates an example of an image 400 that is output by display system 114 after a view has been recorded in accordance with the present invention. As shown in FIG. 4, image 400 includes a viewing area 410, and a recorded image graph 412. Recorded image graph 412 has a horizontal frame line 414 that extends from frame 1 to, in this example, frame 800.

Recorded image graph 412 also has a column of recorded views RV1-RVn. The example of the view that was recorded from frames 150 to 250 is shown in FIG. 4 as a bar that is in the same row as the first recorded view RV1, and extends from frame 150 to frame 250. Once a view has been recorded, the user can select and play the recorded view RV, and watch the recorded view RV displayed in viewing area 410.

Referring again to FIG. 2, once a view has been recorded, method 200 moves to step 216 to determine whether the user wishes to record additional views, edit the recorded views, or exit. If the user has completed recording views for the moment, method 200 moves to step 218 to exit. If the user wishes to edit the recorded views, method 200 moves to step 220 to edit the views.

If additional views are to be recorded, method 200 returns to step 214 to record another view. The second and subsequent views can be positioned to capture any portion of the recorded action sequence. For example, when a second view is recorded, the time or frame of the action sequence where the recording begins can be the same as the first view. In this case there are two views of the same action sequence

Alternately, the time or frame of the action sequence where the recording begins can be different from the first view. For example, the time or frame of the action sequence where the recording begins for the second view can occur after the time or frame of the action sequence where the recording stopped for the first view. In this case, there are two views of different portions of the action sequence.

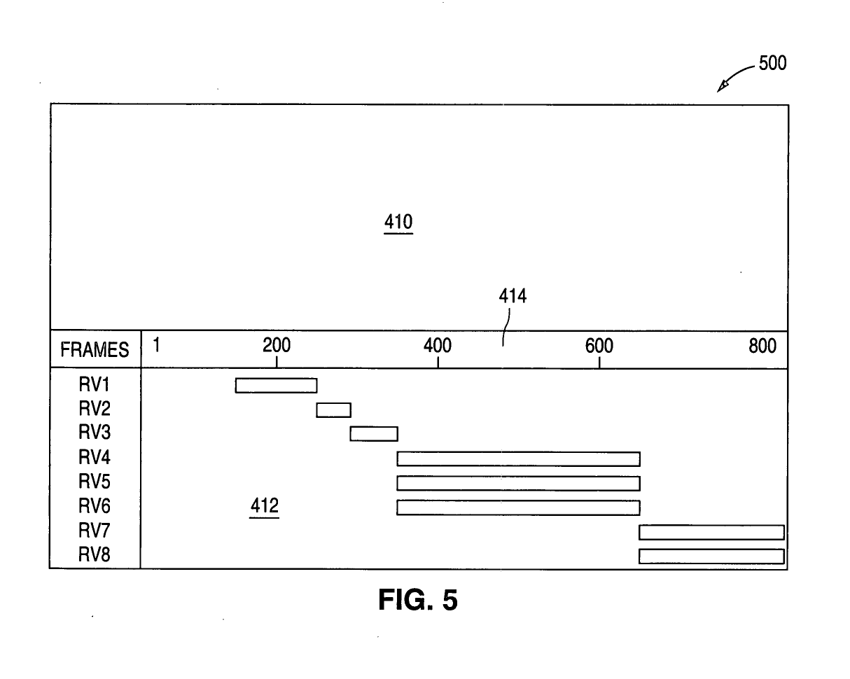

FIG. 5 shows a view that illustrates an example of an image 500 that is output by display system 114 after a number of views have been recorded in accordance with the present invention. Image 500 is similar to image 400 and, as a result, utilizes the same reference numerals to designate the structures which are common to both images.

As shown in FIG. 5, image 500 differs from image 400 in that image 500 includes entries for recorded views RV2-RV8. In this example, recorded view RV1 is a stationary view taken down the lane towards the village and shows, from frame 150 to frame 250, a horseman riding away from the view. Recorded view RV2 is a close-up view of the horse's face and shows, from frame 250 to frame 280, the horse's expression at a full gallop. In this case, recorded view RV2 moves in the same direction and at the same speed as the horseman object.

Recorded view RV3 is taken along side the path as the horseman passes the attacking creatures at the entrance of the village and shows, from frame 280 to frame 360, a rotating view that follows the approaching and then passing horseman. Recorded views RV4-RV6 show three different views, from frame 360 to frame 650, of the horse rearing up, and the horseman dismounting and slaying two creatures.

Further, recorded views RV7-RV8 show, from frame 650 to frame 800, two different views of the horseman running to and entering a building. Thus, the recorded views RV can include stationary views, rotating views, and views that move alongside an object along the defined path. (The above are merely examples. Any number of views of the object following the action sequence can be recorded, with any speed and direction relative to the moving object. In addition, views of the world that do not include the moving object can also be recorded.)

As noted above, method 200 moves to step 220 to edit the views when the user elects to edit the views. FIG. 6 shows a flow chart that illustrates a method 600 of editing the recorded views in accordance with the present invention. As shown in FIG. 6, method 600 begins at step 610 by determining whether a play command or an edit command has been selected.

When the play command is selected, method 600 moves to step 612 to determine if all of the recorded views or a selected recorded view is to be played. When a selected recorded view is to be played, method 600 moves to step 614 to play the selected view in viewing area 410. When all of the recorded views are to be played, method 600 moves to step 616 to display each recorded view in viewing area 410 in sequence from top-to-bottom RV1 to RV8.

When the edit command is selected, method 600 moves to step 618 where the user selects a portion or portions of each recorded view RV to keep as an edited view. A portion of a recorded view can be selected to be kept by, for example, positioning the cursor over the first frame of a to-be-deleted portion, clicking and dragging the cursor over to the last frame of the to-be-deleted portion, and then selecting the delete command.

This action leaves the edited view, the portion to be kept. As a result, the edited view has a time duration that is less than the time duration of the recorded view. (Each deleted item can be restored, and the edited recorded views can also be restored until saved.) Once a portion of a recorded view RV has been deleted, method 600 returns to step 610.

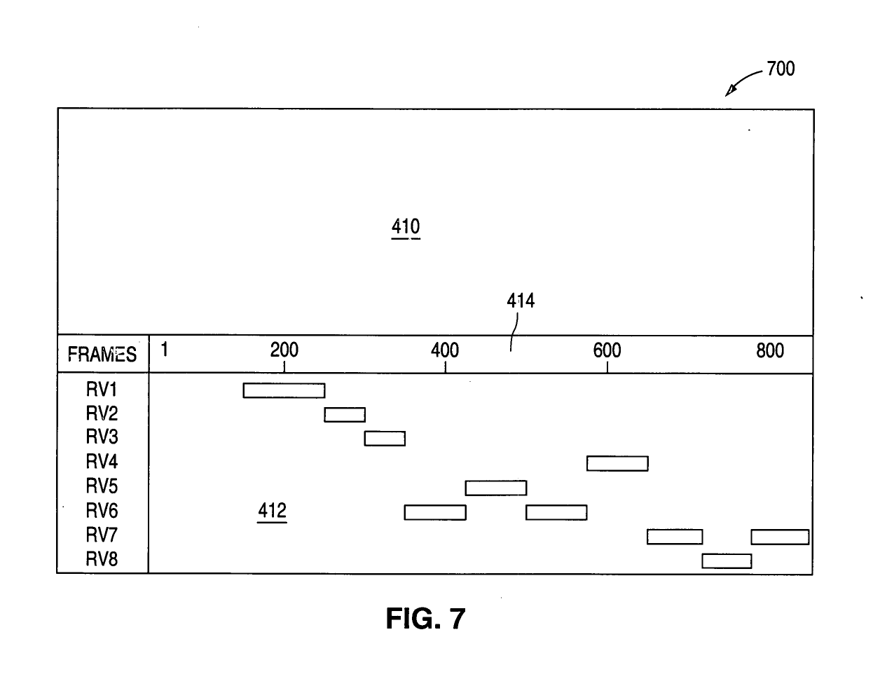

FIG. 7 shows a view that illustrates an example of an image 700 that is output by display system 114 after a number of views have been edited to form an edited sequence of views in accordance with the present invention. Image 700 is similar to image 500 and, as a result, utilizes the same reference numerals to designate the structures which are common to both images.

As shown in FIG. 7, image 700 differs from image 500 in that image 700 shows that recorded views RV4-RV8 have been edited to form an edited sequence of views. In this example, when the play all command is input, display system 114 displays recorded views RV1-RV3 in order, then displays sections of recorded view RV6, RV5, RV6, and RV4 in sequence. Following this, display system 114 displays sections of recorded views RV7, RV8, and RV7 in sequence.

Referring again to FIG. 2, once a view has been recorded, method 200 moves back to step 216 to determine if additional views are to be recorded, if additional editing is to be performed, or if the edited sequence of action is to be output in one of a number of different formats, such as to a disk or a video cassette.

Thus, a method of defining a sequence of views has been described. One of the significant advantages of the method is the ability to record any view of an object following an action sequence, including a view that moves along with, and even around, the object following the path. This gives the director the freedom to try a number of different views of the moving object, and then edit the views to produce an edited sequence of views that reflects the director's style of filmmaking.

If the director is unsatisfied with any aspect of the edited sequence of views, a new view can be recorded and used to replace any view in the edited sequence of views. As a result, a director can largely define the final sequence of views that the audience will see on the screen before one frame of animation has been created.

Knowing a close version of the final sequence of views gives the special effects company the ability to estimate costs with far greater precision than was previously possible, and also dramatically reduce the costs required to produce an animation sequence, even allowing for creative changes that require new frames to be animated.

It should be understood that the above descriptions are examples of the present invention, and that various alternatives of the invention described herein may be employed in practicing the invention. Thus, it is intended that the following claims define the scope of the invention and that structures and methods within the scope of these claims and their equivalents be covered thereby.

What is claimed is:

1. A method of defining a sequence of views, the method comprising the steps of:
generating a computer-generated object that follows an action sequence in a computer-generated world;
recording a first view of the computer-generated world to form a first recorded view, the first recorded view having a time duration from a first record time to a first stop time; and
recording a second view of the computer-generated world to form a second recorded view, the second recorded view having a time duration from a second record time to a second stop time, the first view and the second view being different.

2. The method of claim 1 wherein the recording a first view step includes the steps of:
positioning the first view at a first location in an orientation in the computer-generated world;
positioning the action sequence to begin at a time or frame; and
recording the first view for a time duration to form the first recorded view.

3. The method of claim 2 wherein the first recorded view includes the computer-generated object following the action sequence.

4. The method of claim 3 wherein the second recorded view includes the computer-generated object following the action sequence.

5. The method of claim 4 wherein the first view remains in a fixed location as the computer-generated object follows the action sequence.

6. The method of claim 4 wherein the first view moves from the first location to a second location as the computer-generated object follows the action sequence.

7. The method of claim 5 wherein the first view has an axis of rotation, and the first view rotates about the axis of rotation as the computer-generated object follows the action sequence.

8. The method of claim 6 wherein the first view has an axis of rotation, and the first view rotates about the axis of rotation as the computer-generated object follows the action sequence.

9. The method of claim 1 wherein the period of time is measured as a plurality of frames.

10. The method of claim 1 wherein the first record time and the second record time are the same.

11. The method of claim 1 wherein the first record time and the second record time are different.

12. The method of claim 1 wherein the second record time occurs after the first stop time.

13. The method of claim 1 wherein the first record time and the first stop time occur during the action sequence.

14. The method of claim 1 and further comprising the step of displaying the first recorded view and the second recorded view in sequence.

15. The method of claim 1 and further comprising the steps of:
selecting a portion of the first recorded view as an edited first view, the edited first view has a time duration that is less than the time duration of the recorded first view;
selecting a portion of the second recorded view as an edited second view; and
displaying the edited first view and the edited second view in sequence.

16. The method of claim 15 wherein the edited second view has a time duration that is less than the time duration of the second recorded view.

17. The method of claim 1 and further comprising the steps of:
selecting a first portion of the first recorded view as an edited first view, the edited first view having a time duration that is less than the time duration of the recorded first view;
selecting a second portion of the first recorded view as an edited second view, the edited second view being different from the edited first view and having a time duration that is less than the time duration of the recorded first view;
selecting a portion of the second recorded view as an edited third view; and
displaying the edited first view, the edited third view, and the edited second view in sequence.

18. The method of claim 17 wherein the edited third view has a time duration that is less than the time duration of the second recorded view.

19. An apparatus that defines a sequence of views, the apparatus comprising:
means for generating a computer-generated object that follows an action sequence in a computer-generated world;
means for recording a first view of the computer-generated world to form a first recorded view, the first recorded view having a time duration from a first record time to a first stop time; and
means for recording a second view of the computer-generated world to form a second recorded view, the second recorded view having a time duration from a second record time to a second stop time, the first view and the second view being different.

20. The apparatus of claim 19 wherein the means for recording a first view step includes:
means for positioning the first view at a first location in an orientation in the computer-generated world;
means for positioning the action sequence to begin at a time or frame; and
means for recording the first view for a time duration to form the first recorded view.
